(19) United States
(12) Patent Application Publication
(10) Pub. No.: US 2025/0129804 A1
(43) Pub. Date: Apr. 24, 2025

(54) THROTTLE DEVICE, FLUID DEVICE AND FLUID SYSTEM

(71) Applicant: Festo SE & Co. KG, Esslingen (DE)

(72) Inventors: Stephan PAECH, Esslingen (DE); Tillmann SEIFFER, Esslingen (DE)

(21) Appl. No.: 18/917,534

(22) Filed: Oct. 16, 2024

(30) Foreign Application Priority Data
Oct. 19, 2023 (DE) 102023128736.2

(51) Int. Cl. F15B 13/043

(52) U.S. Cl. CPC F15B 13/0433; F15B 2211/327; F15B 2211/426; F15B 2211/8855

(57) ABSTRACT

A throttle device has a holding structure, to which a throttle tongue is attached with a proximal end section, which projects into a throttle channel with a distal end section ending freely and divides same into two throttle channel sections. The throttle tongue can be pivoted into various pivot positions depending on the pressure difference prevailing between the two throttle channel sections with accompanying rubber-elastic reversible deformation starting from a neutral position in order to automatically adapt a free flow cross-section to the respective need.

### CROSS-REFERENCE

This application claims the benefit of German application DE 102023128736.2, filed Oct. 19, 2023, which is incorporated herein by reference.

The invention relates to a throttle device, having a throttle member which is arranged on a holding structure and projects into a throttle channel through which a pressurized fluid can flow and which can be moved relative to the holding structure in order to specify differently sized free flow cross-sections of the throttle channel.

The invention also relates to a fluid device, having at least one fluid channel designed for the flow of a pressurized fluid, which is at least partially designed as a throttle channel, which belongs to a throttle device associated with the fluid channel, through which differently sized free flow cross-sections of the throttle channel can be specified.

The invention further relates to a fluid system, having fluid devices in the form of a fluid-actuated drive and a valve device for the fluidic actuation of the fluid-actuated drive, having at least one fluid line connecting the valve device to the fluid-actuated drive for transmitting a pressurized fluid, and having at least one throttle device for throttling a fluid flow between the valve device and the fluid-actuated drive, which fluid flow causes a stroke movement of an output member of the fluid-actuated drive.

A throttle device of the type mentioned above is integrated into a fluid device designed as a throttle valve according to DE 10 2009 056 496 A1. The throttle valve can be used, for example, to regulate the speed of the output member of a fluid-actuated drive, wherein the alternative option is to integrate the throttle device directly into the fluid-actuated drive. The throttle device has a throttle member which projects into a throttle channel and can be moved in a linear manner by means of an adjusting member in order to specify differently sized free flow cross-sections of the throttle channel depending on the application. The set free flow cross-section defines a throttle intensity in terms of a pressurized fluid flowing through and can thus influence the flow of the pressurized fluid. Changing the throttle intensity requires manually operating the adjusting member.

DE 10 2005 032 853 B3 and DE 10 2009 016 198 A1 respectively describe a fluid device of the type mentioned in the introduction, which is a working cylinder or a fluid-actuated linear drive and which is fitted with a throttle device which used for end-position damping.

DE 197 11 227 A1 relates to a valve device in which a valve unit having a plurality of valve modules is mounted on a plate-like mounting base through which fluid channels referred to as consumer channels pass, which are assigned fluidic functional units, for example a throttle device or a pressure regulator.

DE 10 2014 002 142 A1 discloses a check valve, which has an elastically bending membrane element, which is supported on one side by a support rib around which it can bend to release a fluid flow.

According to the applicant's internal knowledge, fluid systems can be assembled in fluid technology, for example in the field of hydraulics and in particular in the field of pneumatics, which contain fluid devices connected to one another by means of one or more fluid lines in the form of a fluid-actuated drive and a valve device. The fluid-actuated drive is formed, for example, according to DE 10 2009 016 198 A1 and the valve device, for example, according to DE 197 11 227 A1. At least one other component of the fluid system which is a fluid line establishes a fluid connection between the valve device and the fluid-actuated drive and enables a fluid flow of a pressurized fluid controlled by the valve device, which can cause a stroke movement of an output member of the fluid-actuated actuator. At least one of the components of the fluid system is fitted with a throttle device, which enables the fluid flow required to drive the output member to be restricted, which ultimately means constricting the free flow cross-section provided by a fluid channel to influence the flow rate often simply referred to as the flow. Such cross-sectional constriction causes a counter-pressure to build up and facilitates smooth, largely jerk-free movement of the output member of the fluid-actuated drive. However, it is generally difficult and time-consuming to find the most suitable throttle setting for a given application.

### SUMMARY OF THE INVENTION

The object of the invention is to take cost-effective measures to enable the throttle intensity of a fluid flow to be set simply, quickly and reliably.

This object is achieved with a throttle device in conjunction with the features mentioned in the introduction by virtue of the fact that the throttle member is designed as a throttle tongue which is attached to the holding structure with a proximal end section and which, starting from the proximal end section, projects into the throttle channel with a distal end section ending freely and divides same into two throttle channel sections following one another in a channel longitudinal direction, wherein the throttle tongue can be pivoted into various pivot positions depending on the pressure difference prevailing between the two throttle channel sections, starting from a neutral position adopted in a pressure-balanced state between the two throttle channel sections, while changing the free flow cross-section of the throttle channel with accompanying rubber-elastic reversible deformation in the direction of the one or other of the two throttle channel sections.

The object is also achieved by a fluid device of the type mentioned in the introduction, in which the throttle device is designed as above.

Finally, the object is also achieved by a fluid system, in which, in conjunction with the features mentioned in the introduction, the at least one throttle device contained is in turn designed as above such that the fluid flow of the pressurized fluid can be restricted via a self-adapting free flow cross-section that is dependent on differential pressure.

The valve device contained in the fluid system expediently has a valve section, which is passed through by a plurality of fluid channels, among which there is at least one working fluid channel provided for the fluidic connection with a fluid-actuated drive to be actuated, wherein the valve section has at least one electrically actuable directional control valve, by means of which a fluid flow of the pressurized fluid that occurs in the at least one working fluid channel can be controlled, wherein at least one and preferably every working fluid channel is fitted with the throttle device.

According to the invention, a throttle device, which is expediently installable or installed once or several times in a fluid device and/or in a fluid system, contains a throttle member in the form of a throttle tongue which is attached to a holding structure and can be pivoted by the resulting pressure force of a pressure difference applied to it during operation. Starting from a proximal end section, in the region of which it is attached to the holding structure, the throttle tongue projects into the associated throttle channel transverse to a channel longitudinal direction and divides the throttle channel into two throttle channel sections following one another in the channel longitudinal direction. As the throttle tongue ends freely at its distal end section opposite the proximal end section, it can be pivoted both in the direction of the one throttle channel section and in the direction of the other throttle channel section by a pressure difference applied to it via the two throttle channel sections, wherein the pivot direction is determined by the pressure difference and is oriented towards the throttle channel section in which the lower fluid pressure prevails. The pivot movement of the throttle tongue changes a distance between the throttle tongue and a channel wall surface of the throttle channel at least partially, which is accompanied by a change of a free flow cross-section of the throttle channel, which is available to a pressurized fluid flowing in the throttle channel. The throttle tongue in the flow path of the pressurized medium generally causes the fluid flow to be restricted, wherein the larger the momentary free flow cross-section, the lower the throttle intensity and, accordingly, the greater the possible flow rate. If there is no pressure difference between the two throttle channel sections and therefore there is a pressure-balanced state between the two throttle channel sections, the throttle tongue is in a position referred to as a neutral position, from which it can be pivoted into various pivot positions if a pressure difference occurs. This pivoting takes place as part of a rubber-elastic reversible deformation with the result that when the throttle tongue deflects from the neutral position, a rubber-elastic restoring force builds up which counteracts a pressure force resulting from the pressure difference in the direction of the neutral position. Depending on the configuration chosen, a degressive or linear or progressive build-up of the restoring force can be specified, for example, depending on the degree of deflection of the throttle tongue. With the throttle device according to the invention, the free flow cross-section of the throttle channel, which can also be referred to as the opening cross-section, is an in particular continuous or constant function of the pressure difference, such that if there is a large pressure difference corresponding to a high fluid requirement, a larger opening cross-section is automatically set, and if there is a low pressure difference corresponding to a lower fluid requirement, a smaller opening cross-section is automatically set. When the throttle device is used in conjunction with the fluidic actuation of a fluid-actuated drive, the result is that a certain counter-pressure is always created, regardless of the size of the drive, which facilitates a smooth stroke movement of the output member of the drive. At the same time, rapid venting is guaranteed in the event of large pressure differences at the start of actuation of a fluid-actuated drive. As the free flow cross-section is automatically set by the flexible pivotable throttle tongue without outside mechanical access solely on the basis of the prevailing pressure difference, this is a self-adaptive system that avoids time-consuming adjustment and verification measures. The pivoting in opposite directions depending on the differential pressure is also associated with a bidirectional flow through the throttle channel, wherein the adaptive throttling occurs in both flow directions, such that, for example, in connection with the fluidic actuation of a fluid-actuated drive, one and the same throttle device can effect both supply air throttling and exhaust air throttling. The throttle device always adapts itself within wide limits to the required fluid flow.

Advantageous embodiments of the invention are given in the dependent claims.

In principle, the throttle tongue and inner contour of the throttle channel can be adapted to one another such that the throttle channel is closed in the neutral position of the throttle tongue, in other words there is no free flow cross-section through which fluid can flow in the region of the throttle tongue. However, it is considered advantageous if the design of the throttle tongue is adapted to the inner contour of the throttle channel in such a way that the throttle channel already has a free flow cross-section in the neutral position of the throttle tongue. This free flow cross-section present in the neutral position is in particular a minimum free flow cross-section, i.e. a free flow cross-section that is smaller than any open free flow cross-section in the possible pivot positions of the throttle tongue. One associated advantage is that even in the event of a minimum pressure difference between the two throttle channel sections that is not enough to pivot the throttle tongue in a rubber-elastic manner, a low flow is possible such that in conjunction with a fluid-actuated drive to be actuated, particularly smooth stroke movements of an output member can be produced.

In one particularly simple design of the throttle device, the channel wall of a fluid channel formed in a fluid device acts directly as a holding structure, with a fastening groove being formed there for example, into which the throttle tongue is inserted in the region of its proximal end section and, for example, clipped in.

However, a design in which the holding structure of the throttle device has a frame-like structure and therefore forms a holding frame completely surrounding the periphery of the throttle channel is preferred. This facilitates the secure attachment of the throttle device, for example in a fluid channel. The inner circumferential surface of the holding frame expediently forms a channel wall surface of the throttle channel, which together with the pivotable throttle tongue limits the variable free flow cross-section of the throttle channel.

It is considered advantageous for the holding frame to have a rectangular cross-sectional contour on the inside, wherein the throttle tongue simultaneously has a rectangular outer contour adapted to the inner contour of the holding frame as seen in the channel longitudinal direction of the throttle channel. The corner regions are expediently rounded. The throttle tongue with a rectangular contour on the outside preferably has a first rectangular side attached to the holding structure in the region of the proximal end section and three moveable rectangular sides, including one in the region of the distal end section. When the throttle tongue is pivoted, the three moveable rectangular sides, which together with the inner contour of the holding frame define the free flow cross-section, can move freely relative to the holding frame, varying the size of the free flow cross-section.

The holding frame preferably also has a rectangular cross-sectional contour on its outside expediently rounded in the corner regions such that it is rectangular both on the inside and outside with rectangular sides assigned to each other in pairs.

It is advantageous for the holding frame to be sleeve-shaped and extend in the channel longitudinal direction of the throttle channel passing through it between two opposite end faces referred to as frame end faces. The throttle tongue can, for example, be attached to the holding frame in the region of one of the two frame end faces. However, it is advantageous if the throttle tongue is attached to the holding frame with its proximal end section in an attachment area spaced apart from the two frame end faces. The two throttle channel sections then respectively extend within the holding frame between the throttle tongue and one of the two frame end faces. The length dimensions of the holding frame are in particular selected such that the throttle tongue is arranged entirely within the holding frame not only in the neutral position, but also in every possible pivot position. The holding frame preferably has the basic shape of a rectangular tube, in particular with rounded corners.

One special feature of the throttle tongue according to the invention is, as already mentioned above, that pivoting from the neutral position in both possible pivot directions is accompanied by a rubber-elastic reversible deformation. A rubber-elastic restoring force therefore builds up during pivoting, which must be overcome or countered by the pressure difference in order to maintain a larger free flow cross-section compared to the neutral position. If the pressure difference is eliminated, the throttle tongue returns to its stress-free neutral position.

One possible design of the throttle device provides that the throttle tongue is rigid and resistant to bending overall and only the attachment area between the proximal end section and the holding structure is rubber-elastic. When it pivots, the throttle tongue behaves like a flap in this case. However, an embodiment is preferred in which the throttle tongue has rubber-elastic properties in its entirety such that it can be bent elastically when it pivots, causing a change in the free flow cross-section. The result of this property is in particular that the throttle tongue, starting from a linear extension that is expediently present in the neutral position, undergoes an arcuate curvature along its length when it is deflected or pivoted in the one or other direction. This behaviour allows a simple specific specification of the change in the degree of opening as a function of the degree of deflection of the throttle tongue, in other words the change in the free flow cross-section as a function of the level of the pressure difference.

In order to maintain the rubber-elastic properties, the throttle tongue is expediently made of an elastomeric material. It is preferably an elastomeric material with viscoelastic properties which advantageously contributes to a slow or delayed opening of the free flow cross-section.

In the case of a flap-like rigid throttle tongue, the rubber-elastic properties are expediently limited to a deformable pivot area for attaching the proximal end section to the holding structure.

The rubber-elastic properties expediently result from the use of polyurethane, in particular a thermoplastic polyurethane that can be easily and precisely moulded by injection moulding.

The throttle tongue is preferably designed such that it has a bending stiffness that decreases from its proximal end section to its distal end section, wherein the bending stiffness decreases in particular continuously. To achieve these properties, it is in particular provided that the cross-section of the throttle tongue decreases from the proximal end section attached to the holding structure to the distal end section. For example, the thickness and/or width of the throttle tongue can have a maximum in the region of the proximal end section and decrease from there to at least approximately the distal end section. One effect of this embodiment is that the free flow cross-section does not change suddenly in the event of pressure changes, but rather only gradually over a wide range of the pressure difference, which is, for example, one bar or more. The opening behaviour can be very easily adapted to the specific conditions of use via the design of the throttle tongue. The change in the free flow cross-section is preferably a continuous or constant function of the pressure difference on the throttle tongue, wherein the dependency on the pressure difference can, for example, be degressive or linear or progressive. In this way, it can, for example, be specified that the increase in the free flow cross-section decreases as the pressure difference increases.

It is advantage in particular for the installation and stability of the throttle device if the throttle device is designed as a throttle unit, in particular one that can be handled as a unit, in which the throttle tongue and the holding structure are integrated. The throttle tongue and the holding structure are preferably integrally formed with one another, wherein the throttle unit can preferably be designed as a one-piece injection-moulded elastomer component. However, the integral structure can, for example, also be achieved thanks to a material bond between the throttle tongue and the holding structure, for example by bonding or laser beam welding. Generally speaking, it is advantageous if the throttle unit is made entirely of a material with rubber-elastic properties, in particular of an elastomeric material.

In its embodiment as a throttle unit, the throttle device has the great advantage that it can be inserted very easily into a fluid channel of a fluid device for its utilization such that it constitutes an insert component inserted into a fluid channel in its use position. For installation, the throttle unit can, for example, be inserted into an associated fluid channel through a channel opening. Depending on the length ratio between the throttle unit and the associated fluid channel, the throttle channel can occupy the entire length or only a partial length of the fluid channel.

For secure attachment and sealing against the wall surface of the fluid channel accommodating it, the throttle unit expediently has at least one rubber-elastic sealing bead which surrounds the throttle channel and rests in a sealing manner against the channel wall surface of the fluid channel in the use position. If there is a sleeve-shaped holding frame, the at least one sealing bead is expediently located on its radial outer circumference.

As already mentioned, the throttle device is preferably designed as part of a fluid device. The fluid device expediently contains at least one fluid channel, into which the throttle unit is inserted as a component such that it can be referred to as an insert component. A fluid device can have a plurality of fluid channels, which are respectively fitted with a throttle unit of the type described. For installation, the throttle unit can, for example, be inserted into the associated fluid channel in the channel longitudinal direction from an opening, wherein it is pressed in or snapped in, for example.

In one preferred embodiment, the fluid device fitted with at least one throttle device is designed as a valve device. The valve device has a valve section, which is passed through by a plurality of fluid channels, wherein at least one of this plurality of fluid channels is a fluid channel provided for the fluidic connection with a fluid-actuated drive to be actuated, designated as a working fluid channel for better differentiation. The valve section of the valve device has at least one electrically actuable directional control valve, by means of which a fluid flow of a pressurized fluid that flows through the at least one working fluid channel can be controlled, which can be used to actuate the drive. Preferably, a fluid flow towards the drive as well as a return flow from the drive can take place through at least one working fluid channel. At least one working fluid channel has the throttle device preferably designed as a throttle unit to enable differential pressure-dependent, self-adapting ventilation and venting of at least one drive chamber of a connected fluid-actuated drive. For example, at the beginning of a stroke movement of the output member of a fluid-actuated drive, a lower flow rate may initially occur due to a certain inertia of the throttle tongue and a relatively small free flow cross-section, even with an initially large pressure difference. As a result, the output member starts up smoothly and uniformly. Only gradually does the free flow cross-section get larger and may remain wide open for a prolonged time until it decreases again towards the end of the stroke movement.

Two working fluid channels connected with one and the same fluid-actuated drive and which are preferably both respectively fitted with a throttle device of the design according to the invention can expediently be controlled by the at least one electrically actuable directional control valve of the valve device.

The valve section of the valve device expediently has a base body separate from the at least one directional control valve, on which body the at least one directional control valve is mounted, in particular releasably. The at least one working fluid channel extends with a channel section referred to as the directional control valve section in the directional control valve and with an adjoining channel section referred to as the base body section in the base body. The throttle device can, for example, be arranged in the directional control valve section of the working fluid channel, but is preferably installed in the base body section such that the valve device can be operated if needed with conventional directional control valves. If a directional control valve without a throttle device needs to be replaced, the associated at least one throttle device can remain in the base body.

With a minimum equipment level, the base body of the valve device is fitted with only one single directional control valve. However, in particular in conjunction with complex automation tasks, it is advantageous if the valve section has a plurality of directional control valves which are lined up on the base body and respectively designed to control a fluid flow that occurs in at least one working fluid channel fitted with the throttle device.

However, there is also the possibility of the valve device being a so-called single valve, the valve section of which has a single directional control valve and does not have a separate base body, for example. In this case, the at least one working fluid channel extends entirely as a valve channel in the directional control valve and expediently accommodates a throttle device of the design according to the invention.

The fluid device fitted with at least one throttle device according to the invention is not necessarily a valve device, but rather can also be another type of fluid device. For example, the fluid device can be a fluid-actuated drive, for example a linear drive or rotary drive, or an independent throttle valve that can be used in combination with other fluid devices and which can be integrated, for example, into the course of a fluid line.

In a fluid system according to the invention, the fluid-actuated drive or the valve device is expediently fitted with at least one throttle device or a throttle device is installed in at least one fluid line connecting the fluid-actuated drive with the valve device.

### BRIEF DESCRIPTION OF DRAWINGS

The invention is explained below in more detail based on the appended drawing. In the drawing:

FIG. 1 shows a fluid device according to the invention in a preferred embodiment as valve device in a perspective view and without illustrating end modules shown in FIG. 5 and attached to the side of a valve section of the valve device in the operational state, wherein the valve device is fitted with a plurality of electrically actuable directional control valves mounted on a base body,

FIG. 2 again shows a perspective view of the valve device shown in FIG. 1 with one of the directional control valves removed from the main body, wherein two throttle devices of preferred design according to the invention integrated into the valve device are shown in a state prior to their installation, one of them in a framed image section VI,

FIG. 3 shows the valve device shown in FIGS. 1 and 2 in a section along section line III-III from FIGS. 1, 4 and 5, wherein in addition another fluid device that can be fluidically controlled by the valve device and is designed as a fluid-actuated drive is also schematically shown and is connected to the valve section of the valve device via two fluid lines such that there is a preferred embodiment of the fluid system according to the invention, wherein the fluid-actuated drive is fitted with sensors, which are connected to optional electrical inputs of the valve device via sensor cables and wherein two throttle devices integrated into the valve device and associated with one of the directional control valves are shown in section,

FIG. 4 shows a section through the valve device according to sectional plane IV-IV from FIGS. 3 and 5,

FIG. 5 shows a top view of the valve device shown in FIGS. 1 to 4 looking in the direction of arrow V from FIGS. 1 and 3, wherein two laterally mounted end modules are shown, as well as a schematic representation of an electronic control unit provided expediently for the electrical control of the valve device,

FIG. 6 is an isometric individual representation of a preferred embodiment of the throttle device according to the invention, which is preferably installed several times in the valve device shown in FIGS. 1 to 5 and which is the throttle device shown in FIG. 2 in the image section VI there,

FIG. 7 shows the throttle device in a frontal view looking in the direction of arrow VII in FIG. 6,

FIG. 8 shows a longitudinal section of the throttle device according to sectional plane VIII-VIII from FIGS. 6, 7 and 9, wherein the throttle tongue shown in its neutral position is shown firstly as a dotted line and secondly as a dashed line in two possible pivot positions, and

FIG. 9 shows a cross-section of the throttle device according to sectional plane IX-IX from FIGS. 6 and 8.

### DETAILED DESCRIPTION OF INVENTION

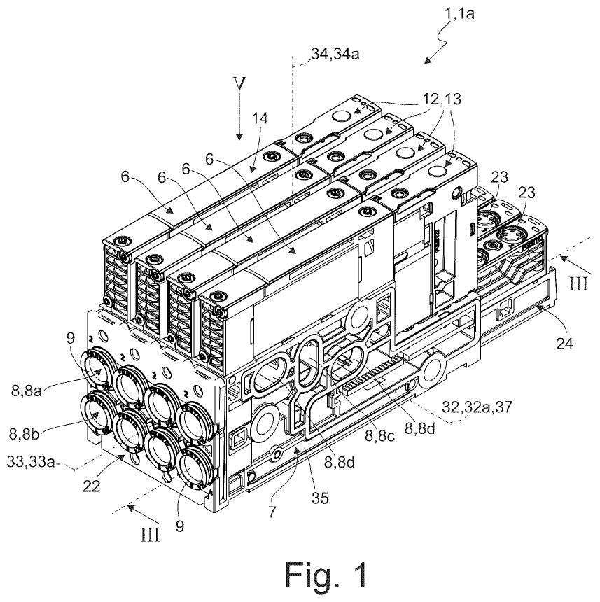

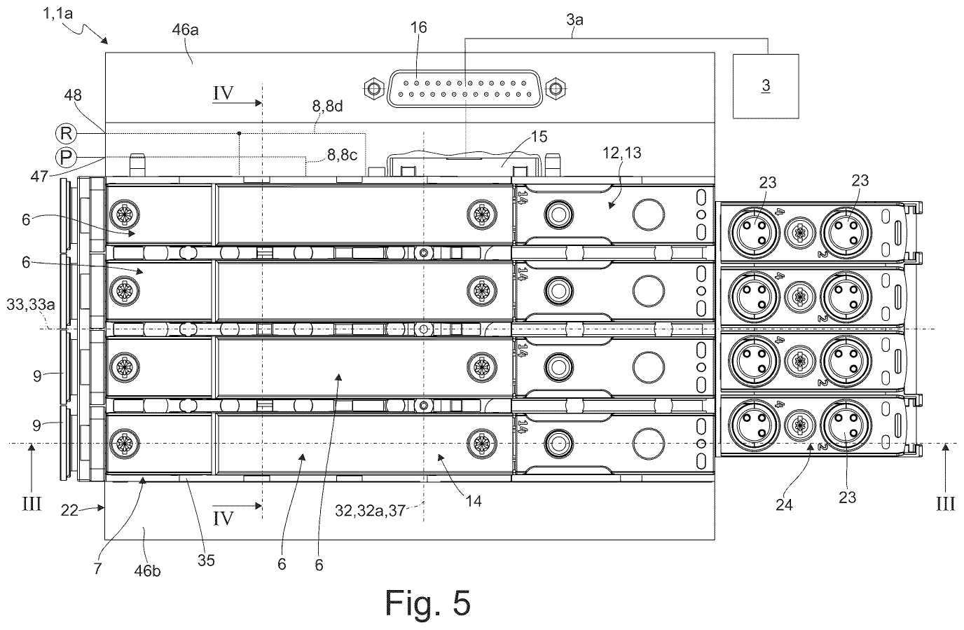

FIG. 5 is a top view of a valve device 1a which is also shown in FIGS. 1 to 4 and which is connected to an optional electronic control unit 3 via at least one electrical control line 3a, which control unit is designed for the operational control of the valve device 1a.

According to the illustration, the electronic control unit 3 can be separate from or external to the valve device 1a or be integrated into the valve device 1a.

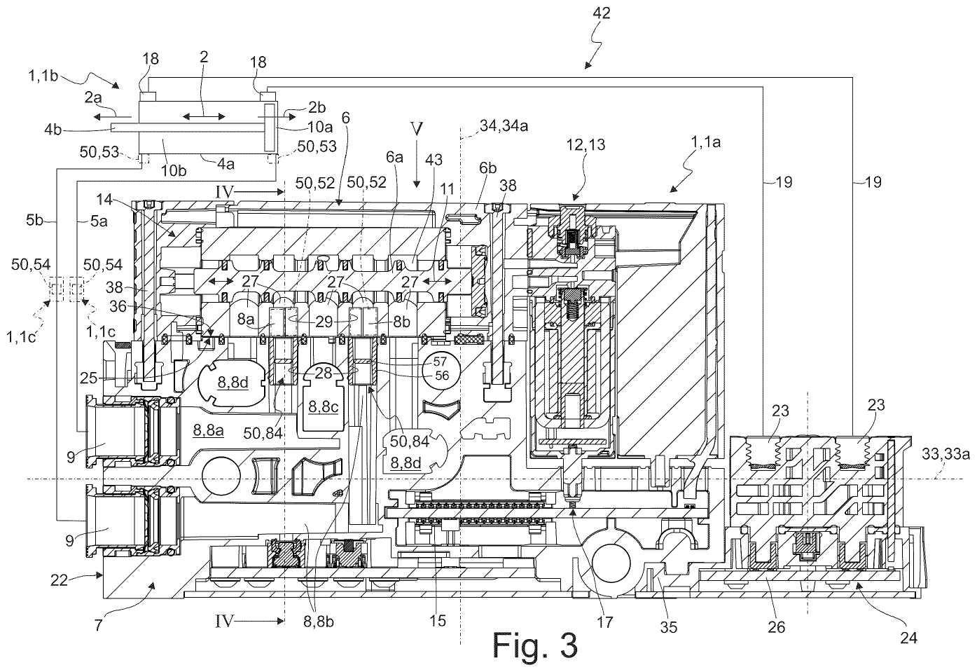

One preferred purpose of the valve device 1a is actuating at least one fluid-actuated drive 1b, wherein FIG. 3 schematically shows such a fluid-actuated drive 1b in a so-called dual-action design. The drive 1b has a drive housing 4a and an output member 4b which can be moved in this respect by executing a stroke movement 2 indicated by a double arrow and which divides two drive chambers 10a, 10b from one another in the drive housing 4a, which are respectively connected to the valve device 1a via one of two fluid lines 5a, 5b. The two fluid lines 5a, 5b can be used to apply controlled fluid to the two drive chambers 10a, 10b and consequently to the output member 4b in order to move the latter back and forth between an illustrated first stroke end position and a second stroke end position spaced apart in this respect while performing the stroke movement 2.

The two drive chambers 10a, 10b are hereinafter also referred to as first and second drive chamber 10a, 10b, and the two fluid lines 5a, 5b are also referred to as first and second fluid line 5a, 5b.

By way of example, the fluid-actuated drive 1b is a linear drive, in particular a working cylinder, but it can also be a rotary drive, for example.

The valve device 1a and the fluid-actuated drive 1b represent different types of fluid devices 1, whose operation is accompanied by the fluid flow of a pressurized medium referred to hereinafter as pressurized fluid. The pressurized fluid can be a hydraulic medium, but it is preferably compressed air.

For the fluidic actuation of the fluid-actuated drive 1b also only referred to as drive 1b hereinafter for the sake of simplicity, the valve device 1a is fitted with an electrically actuable directional control valve 6. Preferably and by way of example, the valve device 1a contains a plurality of such directional control valves 6, which enables independent simultaneous fluidic actuation of a plurality of drives 1b. The further description is based on a valve device 1a having multiple directional control valves 6, although the valve device 1a can also be fitted with only a single directional control valve 6 according to one exemplary embodiment (not shown).

The directional control valves 6 are components of a valve section 7 of the valve device 1a, which is passed through by a plurality of fluid channels 8 through which the pressurized fluid can flow. Below these fluid channels 8 there are two fluid channels 8 referred to as working fluid channels 8a, 8b for each directional control valve 6, which on the one hand communicate with a directional control valve 6 and on the other hand open out on the outside of the valve section 7 on a connection surface 22 with a working connection 9, to which one of the two fluid lines 5a, 5b leading to the fluid-actuated drive 1b, for example in the form of hoses, can be connected or is connected.

The directional control valves 6 are of an electrically actuable design and are respectively fitted with a valve drive 12 that can be actuated by electrical valve control signals. By way of example, each directional control valve 6 is of an electro-pneumatically pilot-controlled design, wherein the valve drive 12 is formed by a pilot valve device 13 having at least one pilot valve, which is combined with a main valve 14 to form a structural unit as directional control valve 6. The pilot valve device 13 can pneumatically actuate the main valve 14 in order to set one of a plurality of switching positions of the directional control valve 6 or of an internal valve member 6a of the directional control valve 6 in which either pressure is applied to the working fluid channels 8a, 8b or they are vented.

The electrical valve control signals can be supplied to the directional control valves 6 via a communication structure 15 which is arranged inside the valve section 15 and which is connected with an electromechanical interface 16 that can be accessed from the outside, to which the electronic control unit 3 can be connected or is connected. The communication structure 15 makes electrical contact with the valve drive 12 of each directional control valve 6 inside the valve section 7 in individual contact regions 17.

The valve device 1a is expediently equipped in such a way that electrical sensor signals that come from sensors 18 arranged on the drive 4 can be taken into account in the electrical actuation of the directional control valves 6. Each directional control valve 6 is typically associated with two sensors 18, which are position sensors arranged on the drive 4 which are respectively able to detect at least one stroke position of the output member 4b. By way of example, each of the two sensors 18 can detect one of the two stroke end positions of the output member 4b and issue corresponding sensor signals.

The sensors 18 are respectively connected to one of a plurality of optional electrical inputs 23 of the valve housing 1a via a preferably multi-core electrical cable referred to as a sensor cable 19. The valve device 1a has, for example, a component which has the electrical inputs 23 and is therefore referred to as the input section 24 and which is attached to the valve section 7. The electrical inputs 23 are electrically connected with the electrical communication structure 15 via an internal electrical conductor assembly 26. Electrical sensor signals issued by the sensors 18 can therefore be transmitted in a sensor-specific manner via the sensor cable 19, the electrical inputs 23, the electrical conductor assembly 26 and the communication structure 15 as feedback signals to the electronic control unit 3, which is able, depending on the sensor signals received, to generate the electrical valve control signals intended for the directional control valves 6 and supply them to the directional control valves 6 via the communication structure 15.

The directional control valves 6 are in particular designed as multi-way valves and have, for example, a 5/2-way valve function. Said valve function is implemented in the main valve 14, which can be actuated by the pilot valve device 13 by means of fluid force. The switching positions of the directional control valve 6 can be specified by the aforementioned valve member 6a, which can be displaced in a valve housing 6b of the directional control valve 6 by the application of fluid by the pilot valve device 13, performing a switching movement 11 indicated by a double arrow, and can thus be positioned in different switching positions. A plurality of valve channels 27 are formed in each directional control valve 6, which are fluidically connected to one another or disconnected from one another in various configurations depending on the switching position of the valve member 6b.

In addition to the two working fluid channels 8a, 8b specifically associated with it, each directional control valve 6 communicates with other fluid channels 8, including a feed fluid channel 8c connected to an external pressure source P and at least one and in particular two vent fluid channels 8d communicating continuously with the atmosphere R.

Each directional control valve 6 or valve member 6a can adopt two switching positions, in which respectively one of the two working fluid channels 8a, 8b is connected to the feed fluid channel 8c and at the same time the other of the two working fluid channels 8b, 8a is connected to a vent fluid channel 29. In this way, the stroke movement 2 of the connected drive 1b can be produced in one of two opposite stroke directions 2a, 2b.

At least one directional control valve 6 can alternatively have a 5/3-way valve function, wherein it is designed such that it enables a third switching position, in particular a centre position, in which the two working fluid channels 8a, 8b are disconnected both from the feed fluid channel 8c and from each vent fluid channel 29.

The overall arrangement comprising the valve device 1a, the fluid-actuated drive 1b and the fluid lines 5a, 5b defines an operational fluid system 42, which enables various applications, in which objects coupled to the output member 4b can be moved and/or positioned by corresponding actuation of the drive 1b, for example in production or assembly technology.

The valve device 1a extends along an imaginary main axis 32, the axial direction of which is referred to as the main direction 32a. Furthermore, the valve bank 2 has an extension in an axial direction of a transverse axis 33, referred to as transverse direction 33a, and in an axial direction of a vertical axis 34, referred to as vertical direction 34a. The transverse axis 33 runs perpendicular to the main axis 32 and the vertical axis 34 extends perpendicular to both the main axis 32 and the transverse axis 33.

The optional input section 24 adjoins the valve section 7 in the transverse direction 33a. The connection surface 22 equipped with the working connections 9 is expediently located on a side of the valve device 1a opposite the input section 24 in the transverse direction 33a.

According to the exemplary embodiment shown, the valve section 7 expediently has a base body 35, which has a valve mounting surface 36 on which the directional control valves 6 are mounted with a valve base surface 25, in particular independently of one another. Each directional control valve 6 is supported on the valve mounting surface 36 with its valve housing 6b having the valve base surface 25. Attachment is expediently by means of fastening screws 38.

The plurality of directional control valves 6 are arranged next to one another in a lined-up direction 37 marked by a dash-dotted line and coinciding, for example, with the main direction 32a and respectively sit on a mounting point of the base body 35 formed by a partial surface of the valve mounting surface 36. The feed fluid channel 8c and each vent fluid channel 8d extend in the base body 35 in a lined-up direction 37 and respectively open out at the valve mounting surface 36 to each mounting point where they respectively communicate with one of the plurality of internal valve channels 27 of the directional control valve 6 mounted on the mounting point in question.

The communication structure 15 is preferably strand-shaped and extends inside the base body 35 in the lined-up direction 37 of the directional control valves 6. It is preferably formed by a printed circuit board arrangement. The communication structure 15 expediently has electrical contact surfaces in the contact regions 17, with which the pivot valve devices 13 are electrically contacted.

The valve section 7 expediently has a first and second end module 46a, 46b, which are respectively mounted on one of the two end faces of the base body 35 pointing in the lined-up direction 37. The end modules 46a, 46b close the feed fluid channel 8c and the vent fluid channel 8d. The electromechanical interface 16 is, for example, arranged on the outside of the first end module 46a and communicates internally with the communication structure 15.

On at least one of the two end modules 46a, 46b, for example on the first end module 46a, there is a connection opening 47 communicating with the feed fluid channel 8c and at least one vent opening 48 communicating with the at least one vent fluid channel 8d. The connection opening 47 enables the connection of an external pressure source P providing the pressurized fluid and the vent opening 48 enables venting to the atmosphere R.

Whilst the base body 35 is, for example, formed in one piece, it can, according to one exemplary embodiment (not shown), be segmented in the lined-up direction 37 and be composed of a plurality of base body modules jointed together, which are respectively fitted with one or more of the directional control valves 6.

The valve device 1a can also be designed in such a way that the valve housing 6b of at least one directional control valve 6 forms an integral unit with the base body 35.

As far as the working fluid channels 8a, 8b are concerned, each directional control valve 6 is individually assigned a fluid channel pair consisting of a first working fluid channel 8a and a second working fluid channel 8b. Each working fluid channel 8a, 8b has a channel section formed in the base body 35 and referred to as the base body section 28 and an adjoining channel section formed in the associated directional control valve 6, which is referred to as the directional control valve section 39.

The base body section 28 is connected at one end to one of the working connections 9 and at the other end opens out with a channel opening, referred to as the base body section opening 28a, at the associated mounting point of the valve mounting surface 36. Each directional control valve section 29 forms one of the valve channels 27 and opens out at the valve base surface 25 with a channel opening referred to as a directional control valve section opening 29a, which is opposite one of the base body section openings 28a. In this way, the directional control valve sections 39 and the base body sections 28 of the fluid working channels 8a, 8b are fluidically connected to one another in pairs.

Inside the valve housing 6b, the valve channels 27 open at a distance from one another into a valve member accommodating space 43 formed in the valve housing 6b, in which the valve member 6a, formed by way of example as a valve spool and movable relative to the valve housing 6b, extends. Actuation on the part of the valve drive 12 can position the valve member 6b in the aforementioned two switching positions, which are referred to as first and second switching position. In a first switching position shown in FIG. 3, the first working fluid channel 8a is only connected to the feed fluid channel 8c, whilst at the same time the second working fluid channel 8b is only connected to one of the vent fluid channels 8d. In the second switching position, it is the second working fluid channel 8b that is only connected to the feed fluid channel 8c, whilst at the same time the first working fluid channel 8a is connected to one of the vent fluid channels 8d. As a result, in the first switching position, the first drive chamber 10a connected to the first working fluid channel 8a via the first fluid line 5a is ventilated, whilst at the same time the second drive chamber 10b connected to the second working fluid channel 8b via the second fluid line 5b is vented. As a result of this, the output member 4b is driven from the first stroke end position to perform a stroke movement 2 in an extension direction 2a. In the second switching position, the second drive chamber 10b is ventilated and the first drive chamber 10a is vented such that the output member 4b, starting from the second switching position, performs a stroke movement 2 in a retraction direction 2b opposite the extension direction 2a.

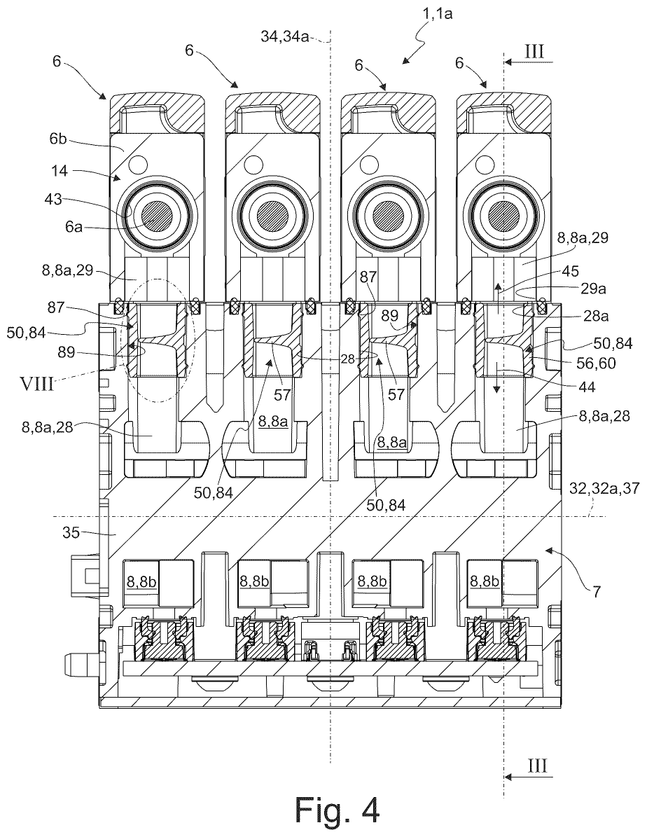

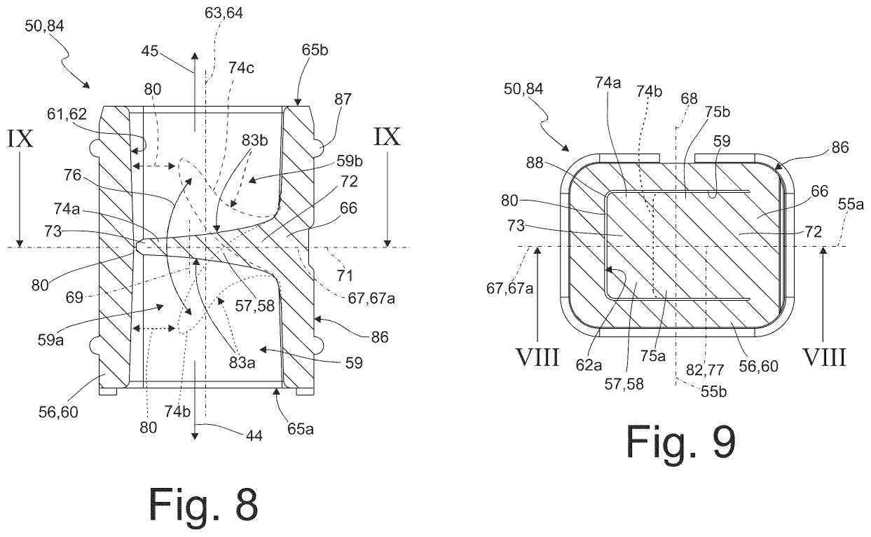

Depending on the switching position of the valve member 6a, the pressurized fluid used consequently flows through each working fluid channel 8a, 8b with a fluid flow in either a first flow direction 44 or in an opposite second fluid direction 45, wherein these flow directions 44, 45 are shown in the drawing by arrows in FIGS. 4 and 8.

When the output member 4b of the drive 1b performs the stroke movement 2, fluid flows consequently occur between the valve device 1a and the drive 1b, by means of which, depending on the direction of movement of the stroke movement 2, respectively one of the two drive chambers 10a, 10b is ventilated and at the same time the other of these two drive chambers 10a, 10b is vented. These fluid flows form in the two working fluid channels 8a, 8b and in the fluid lines 5a, 5b connecting the working fluid channels 8a, 8b to the drive chambers 10a, 10b.

Compared with the maximum possible flow rates due to the nominal cross-sectional geometries of the working fluid channels 8a, 8b and the fluid lines 5a, 5b, the aforementioned fluid flows are expediently restricted fluid flows with reduced flow rate or reduced flow, which is reflected, for example, in a smooth, jerk-free and non-sudden stroke movement 2 of the output member 4b. The cause of the restriction is at least one throttle device 50, with which the fluid system 42 or at least one fluid device 1 is fitted. By way of example, every fluidic connection which is present between a directional control valve 6 and the associated drive 1b and contains one of the two working fluid channels 8a, 8b and one of the two fluid lines 5a, 5b contains such a throttle device 50. One special feature of each of these throttle devices 50 is that they are designed to be self-adapting depending on the differential pressure and, on the basis of a pressure difference of the pressurized fluid applied to them, enable an optimum free flow cross-section for the fluid flow and, accordingly, an optimum flow rate of the pressurized fluid to the drive 1b and back from the drive 1b.

In principle, a design is possible where a self-adapting throttle device 50 is contained in only one of the aforementioned fluidic connections 8a, 5a; 8b, 5b; however, it is advantageous if, according to the exemplary embodiment shown, both fluidic connections 8a, 5a; 8b, 5b are respectively fitted with such a throttle device 50.

The respective throttle device 50 is preferably designed as part of the valve device 1a, which applies to the exemplary embodiment shown. By way of example, each of the two working fluid channels 8a, 8b is fitted with a version of said throttle device 50. It is particularly advantageous if the throttle device 50 is arranged in the base body section 28 of the associated working fluid channel 8a, 8b, i.e. is located in the base body 35 of the valve section 7 of the valve device 1a. Alternatively, according to the positioning indicated with dot-dashed lines with reference 52 in FIG. 3, the throttle device 50 can, for example, also be arranged in the directional control valve section 29 of the working fluid channel 8a, 8b and therefore in the associated directional control valve 6.

Further positioning options for the throttle device 50 include integration into the fluid-actuated drive 1b also representing a fluid device 1, which is indicated with dot-dashed lines with reference 53. The throttle device 50, 53 can, for example, be attached to the outside of the drive housing 4a or installed in the drive housing 4a.

Another potential location to position the throttle device 50 is in the course of a fluid line 5a, 5b, which is indicated with dot-dashed lines with reference 54. In this case, the throttle device 50, 54 is expediently part of a fluid device 1 designed as an independent throttle valve 1c.

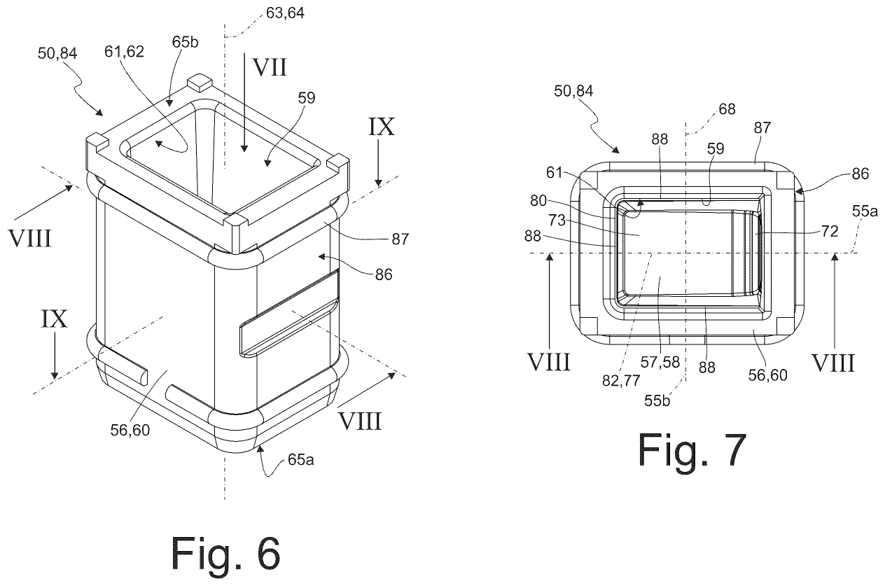

A preferred design of the self-adapting throttle device 50 installed, for example, once or several times in a fluid device 1, is shown in detail in FIGS. 6 to 9 and is explained in more detail below.

The throttle device 50 has a holding structure 56 and a throttle member 58 which is attached to the holding structure 56 and designed as a throttle tongue 57 that can be pivoted with respect to the holding structure 56.

The holding structure 56 preferably has a frame-like design and is therefore also referred to as a holding frame 60 hereinafter. The holding frame 60 surrounds the periphery of a flow channel of the throttle device 50 referred to as the throttle channel 59 such that a radial inner circumferential surface 61 of the holding frame 60 forms a channel wall surface 62 completely surrounding the throttle channel 59.

The throttle channel 59 has a channel longitudinal direction 63 which is shown by a dot-dashed line and which extends, for example, in the axial direction of a central frame longitudinal axis 64 of the holding frame 60. According to one exemplary embodiment (not shown), the holding frame 60 can be annular with small dimensions in the channel longitudinal direction 63. However, a sleeve-shaped design of the holding frame 60 is preferred, in particular with an overall length that is greater than a maximum diameter of the throttle channel 59. This applies to the exemplary embodiment shown.

The holding frame 60 extends in the channel longitudinal direction 63 between two opposite first and second frame end faces 65a, 65b pointing axially away from each other. The throttle tongue 57 is arranged in the throttle channel 59 and is attached to the holding frame 60 in an attachment area 66 spaced apart from the two frame end faces 65a, 65b.

The throttle tongue 57 preferably has a flat shape with a central main extension plane 71. The main extension plane 71 is spanned by a longitudinal axis 67 and a transverse axis 68 of the throttle tongue 57 orthogonal thereto. The throttle tongue 57 also has a vertical axis 69 orthogonal to the longitudinal axis 67 and the transverse axis 68, in the axial direction of which the thickness of the throttle tongue 57 is measured, wherein this tongue thickness is expediently consistently smaller than a tongue length measured in the axial direction of the longitudinal axis 67 and a tongue width measured in the axial direction of the transverse axis 68.

The throttle tongue 57 has on its rear side a proximal end section 72 orientated in the axial direction of the longitudinal axis 67, also referred to below as the longitudinal direction 67a, and a distal end section 73 on its front side which is opposite to this in the longitudinal direction 67a. The throttle tongue 57 is attached to the holding frame 60 with its proximal end section 72 in the attachment area 66. Starting from the distal end section 73 or the attachment area 66, the throttle tongue 57 extends into the throttle channel 59 transverse to the channel longitudinal direction 63 or transverse to the frame longitudinal axis 64, wherein it ends freely with its distal end section 73 inside the throttle channel 59 without any attachment measures.

In a neutral position of the throttle tongue 57 shown in the drawing and indicated by solid lines in FIG. 8, the main extension plane 71 preferably runs at least substantially orthogonally to the channel longitudinal direction 63 or the frame longitudinal axis 64.

Apart from its proximal end section 73, the throttle tongue 57 is not connected to the holding structure 56. Accordingly, the throttle tongue 57 is freely moveable with respect to the holding structure 56 or the holding frame 60 both at its distal end section 73 and at the two lateral tongue edge sections 75a, 75b extending between the proximal end section 72 and the distal end section. In this way, the throttle tongue 57 is able to carry out a pivot movement 76 relative to the holding structure 56, which movement is indicated by a double arrow in FIG. 8 and is also referred to as a tongue pivot movement 76 hereinafter for better differentiation. The tongue pivot movement 76 expediently takes place at least substantially in a pivot plane 77 coinciding with the channel longitudinal direction 63 or the frame longitudinal axis 64. The longitudinal axis 67 of the throttle tongue 57 lies in the pivot plane 77.

The throttle channel 59 is divided into two throttle channel sections 59a, 59b following one another in the channel longitudinal direction 63, which are hereinafter also referred to as first and second throttle channel section 59a, 59b, by the throttle tongue 57 projected into it and preferably formed like a tab. The tongue pivot movement 73 can be infinitely variable starting from the neutral position 74a both in the direction of the first throttle channel section 59a and in the direction of the second throttle channel section 59b. The positions that can be adopted by the throttle tongue 57 are referred to as pivot positions, wherein two possible pivot positions are indicated in FIG. 8 for illustration, firstly a first pivot direction 74b deflected towards the first throttle channel section 59a and shown by dotted lines and secondly a second pivot position 74c deflected towards the second throttle channel section 59b and shown by dashed lines. The second pivot position 74c is also shown by dashed lines in FIG. 9.

The first throttle channel section 59a extends between the throttle tongue 57 and the first frame end face 65a, the second throttle channel section 59b extends between the throttle tongue 57 and the second frame end face 65b. The distance between the attachment area 66 and the two frame end faces 65a, 65b measured in the channel longitudinal direction 63 is preferably dimensioned such that the throttle tongue 57 is arranged completely within the throttle channel 59 not only in the neutral position, but also in every possible pivot position.

In the exemplary embodiment shown, the throttle tongue 57 has rubber-elastic properties in its entirety. It can therefore be reversibly bent, in particular transversely to the main extension plane 71, in a rubber-elastic manner such that it undergoes an arcuate curvature in a plane of curvature 82 orthogonal to the main extension plane 71. The plane of curvature 82 coincides with the pivot plane 77. When the throttle tongue 57 is pivoted towards the first throttle channel section 59a, it has a concave curvature on a first tongue main surface 83a facing the first throttle channel section 59a, and a convex curvature on its opposite second tongue main surface 83b facing the second throttle channel section 59b. When the throttle tongue 57 is pivoted from the neutral position 74a towards the second throttle channel section 59b, the first tongue main surface 83a is convexly curved and the second tongue main surface 83b is concavely curved.

The rubber-elastic properties of the throttle tongue 57 are preferably due to the fact that the throttle tongue 57 is made of an elastomeric material, in particular of a thermoplastic polyurethane. It is advantageous if the elastomeric material used has viscoelastic properties.

The holding structure 56 preferably also has rubber-elastic properties, wherein it is made of the same material as the throttle tongue 57, for example. The throttle tongue 57 and holding structure 56 are preferably integrated into an assembly that can be handled as unit referred to as a throttle unit 84. The throttle unit 84 is expediently a one-piece body, inside of which the throttle tongue 57 and the holding structure 56 are integrally formed with one another in the attachment area 66. The entire throttle unit 84 is manufactured in particular as an injection-moulded part from a thermoplastic elastomeric material.

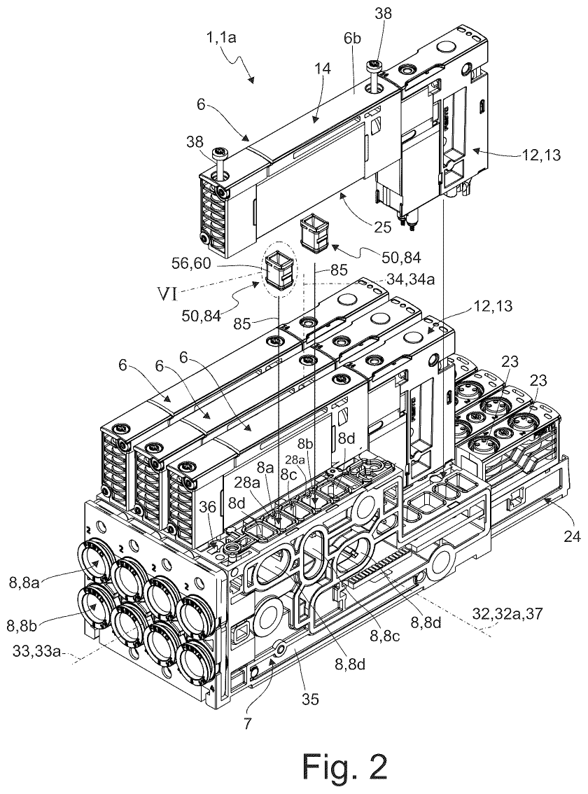

When used as intended, the throttle device 50 expediently assumes a use position in which it is arranged in the course of a fluid channel 8 of a fluid device 1. Such a use position of the throttle device 50 can be clearly seen in the valve device 1a in FIGS. 3 and 4. Here, a version of the throttle device 50 designed as a throttle unit 84 is inserted into each working fluid channel 8a, 8b. Due to this use as an insert, the throttle unit 84 can be referred to as an insert component. It is installed in the associated working fluid channel 8a, 8b in particular by inserting it, with a directional control valve 6 removed from the valve mounting surface 36, through a then freely accessible directional control valve section opening 29a into one of the directional control valve sections 29 of a working fluid channel 8a, 8b according to assembly arrow 85 as shown in FIG. 2, and in particular by inserting it such that it assumes the use position.

The holding frame 60 is preferably adapted on its outer circumference radially opposite the throttle channel 59 to the inner contour of the longitudinal section of the associated working fluid channel 8a, 8b accommodating it in the use position in such a way that a press fit fixation is achieved, which ensures that the throttle unit 84 is held securely and axially immobile regardless of the prevailing pressure conditions. It is understood that alternatively or in addition, a positive locking in the channel longitudinal direction 63 can also be provided in the use position.

In the region of the outer circumference 86, the holding structure 56 expediently has at least one radially protruding rubber-elastic sealing bead 87 that extends around the throttle channel 59. In the use position of the throttle unit 84, this sealing bead 87 is pressed against the wall surface 89 of the working fluid channel 8a, 8b accommodating the throttle unit 84 such that no leakage flow can occur between the outer circumference 86 and the wall surface 89 of the working fluid channel 8a, 8b.

The throttle tongue 57 is in its neutral position due to its inherent stability when no external forces are acting on it. This is, for example, the case when the throttle device 50 has not yet been installed as intended in its use position or when the use position is assumed if the associated working fluid channel 8a, 8b is completely vented and accordingly both throttle channel sections 59a, 59b are depressurized or atmospheric pressure prevails there.

The throttle tongue 57 also assumes the neutral position when there is overpressure in the throttle channel 59 and the fluid pressures are equally large in the two throttle channel sections 59a, 59b. A pressure-balanced state then prevails between the two throttle channel sections 59a, 59b, wherein the pressure forces acting on the throttle tongue 57 are equally large in the two flow directions 44, 45.

Starting from the neutral position, the throttle tongue 57 can be caused to perform an aforementioned tongue pivot movement 76 by the pressurized fluid in the throttle channel 59 depending on the pressure difference that prevails between the two throttle channel sections 59a, 59b, as part of which it is pivoted into a pivot position towards the throttle channel section 59a, 59b with lower fluid pressure. This makes the first pivot position 74b or the second pivot position 74c possible, for example. The greater the pressure difference, the greater the pivot angle of the tongue pivot movement and accordingly the degree of deflection of the throttle tongue 57.

Pivoting the throttle tongue 57 changes a free flow cross-section 80 of the throttle channel 59 available to the pressurized fluid for flowing past the throttle tongue 57. The outer contour of the throttle tongue 57 is preferably adapted to the inner contour of the throttle channel 59 such that in the neutral position of the throttle tongue 57 there is already a free flow cross-section 80, which is, however, relatively small. This is in particular a minimum or smallest free flow cross-section, relative to any possible position of the throttle tongue 57. Any open free flow cross-section 80 in the possible pivot positions of the throttle tongue 57 is larger than the minimum free flow cross-section in the neutral position of the throttle tongue 57.

In principle, the throttle device 50 can be designed such that the throttle channel 59 is closed in the neutral position of the throttle tongue 57 as a result of existing contact between the throttle tongue 57 and the channel wall surface 62 and a free flow cross-section 80 is only created when the throttle tongue 57 pivots. However, a design is preferred with a free flow cross-section present both in the neutral position and in every pivot position, which applies to the exemplary embodiment shown.

The pivoting of the throttle tongue 57 from the neutral position is accompanied by a rubber-elastic reversible deformation, which occurs, for example, both in the attachment area 66 and within the entire throttle tongue 57 and as a result of which a restoring force that counteracts the differential pressure force builds up. The choice of material and/or design of the throttle tongue 57 can be used to specify a certain dependence of the resulting restoring force on the pivot angle of the tongue pivot movement 76. This can influence what cross-sectional change the free flow cross-section 80 undergoes during the tongue pivot movement 76 and accordingly in the event of different pressure differences.

It is, for example, possible that the cross-sectional change of the free flow cross-section 80 is a constant function of the pressure difference, wherein it depends on the pressure difference in a degressive, linear or progressive manner, for example. In any case, the differential pressure-dependent pivotability of the throttle tongue 57 results in a kind of self-adaptation of the free flow cross-section 80 to the prevailing pressure difference such that, for example, if there is a large pressure difference and accordingly a high fluid requirement, a large free flow cross-section is set, and if there is a small pressure difference with an accordingly lower fluid requirement, however, a smaller free flow cross-section is set. When using the fluid system 42 shown in FIG. 3, a certain counter-pressure is thus always created, regardless of the size of the drive 1b and the volume of its drive chambers 10a, 10b, which ensures a smooth motion sequence of the stroke movement 2. At the same time, in the event of large pressure differences at the start of the stroke movement 2, rapid venting of the drive chamber 10a or 10b, which is currently connected to a vent fluid channel 8d, is also ensured. The throttle device 50 adapts itself within further limits to the fluid flow and in particular compressed air flow required for operation of the connected drive 1b.

One design of the throttle tongue 57 present in the exemplary embodiment is reflected in a continuously decreasing bending stiffness of the throttle tongue 57 from the proximal end section 72 to the distal end section 73. This is achieved in particular by virtue of the fact that the tongue cross-section, as seen in a plane orthogonal to the longitudinal axis 67 of the throttle tongue 57, decreases from the proximal end section 72 towards the distal end section 73, in particular at least substantially continuously. In this way, a degressive deformation characteristic of the throttle tongue 57 can in particular be achieved.

By way of example, the tongue width of the throttle tongue 57 is constant over the entire tongue length, which can be seen clearly in particular in FIG. 9. The bending stiffness decreasing towards the distal end section is the result of a decreasing tongue thickness, which is greatest in the proximal end section 72 and smallest in the distal end section 73, which can be clearly seen in particular in FIG. 8.

The throttle channel 59 expediently has a rectangular channel cross-section, which is the result, for example, of the holding frame 60 having a rectangular cross-sectional contour on the inside, which can be clearly seen in particular in FIGS. 7 and 9. The channel cross-section has a central cross-sectional longitudinal axis 55a and a central cross-sectional transverse axis 55b orthogonal thereto. The length of the channel cross-section of the throttle channel 59 measured in the axial direction of the cross-sectional longitudinal axis 55a is preferably greater than the width measured in the axial direction of the cross-sectional transverse axis 55ba. However, there could also be a square channel cross-section, for example.

In connection with this, the throttle tongue 57 preferably has a rectangular outer contour as seen in the channel longitudinal direction 63. The proximal end section 72 and the distal end section 73 on the one hand, and the two lateral tongue edge sections 75a, 75b on the other, respectively define two rectangular sides of the throttle tongue 57 opposite each other in pairs.

The throttle tongue 57 is arranged in the throttle channel 59 in particular such that its longitudinal axis 67 coincides with the cross-sectional longitudinal axis 55a of the throttle channel 59 and its transverse axis 68 with the cross-sectional transverse axis 55b of the throttle channel 59.

The throttle tongue 57 is only attached to the holding frame 60 in the region of the proximal end section 72; in contrast, it is freely moveable on the other three rectangular sides 73, 75a, 75b. In the neutral position of the throttle tongue 57, a U-shaped flow gap 88 that defines the aforementioned minimum free flow cross-section extends along the two lateral tongue edge sections 75a, 75b and the distal end section 73. It results from a distance greater than zero between the three rectangular sides 73, 75a, 75b and the channel wall surface 62. The cross-sectional increase of the free flow cross-section 80 when the throttle tongue 57 pivots results in particular from an increase in the distance between the distal end section 73 and the opposite wall surface section 62 of the rectangularly contoured channel wall surface 62.

By way of example, the holding frame 60 is also rectangularly contoured in the region of its outer circumference 86. The holding frame 60 thus has a shape similar to a rectangular tube, for example. The working fluid channels 8a, 8b are also provided with a rectangular cross-section, at least in those areas in which they are fitted with a throttle device 50, which cross-section is adapted to the outer contour of the holding frame 60.

The bidirectional pivotability of the throttle tongue 57, starting from the neutral position, enables the pressurised fluid to flow bi-directionally in both the first flow direction 44 and the second flow direction 45, wherein self-adaptive throttling takes place respectively. As a result, when using the fluid system 42, the flow rate of the pressurized fluid can be variably adjusted in both flow directions, i.e. both in a fluid flow from the valve device 1a to the drive 1b and from the drive 1b back to the valve device 1a.

The throttle device 50 can also be installed within a fluid device 1 or fluid system 42 at a location other than in the course of a working fluid channel 8a, 8b, depending on requirements. In principle, installation in any available fluid channel 8 is possible in which a throttle function is desired.

1. A throttle device, comprising:
a throttle member which is arranged on a holding structure and projects into a throttle channel through which a pressurized fluid can flow and which can be moved relative to the holding structure in order to specify differently sized free flow cross-sections of the throttle channel,
wherein the throttle member is designed as a throttle tongue which is attached to the holding structure with a proximal end section and which, starting from the proximal end section, projects into the throttle channel with a distal end section ending freely and divides same into two throttle channel sections following one another in a channel longitudinal direction,
wherein the throttle tongue can be pivoted into various pivot positions depending on the pressure difference prevailing between the two throttle channel sections, starting from a neutral position adopted in a pressure-balanced state between the two throttle channel sections, while changing the free flow cross-section of the throttle channel with accompanying rubber-elastic reversible deformation in the direction of the one or other of the two throttle channel sections.

2. The throttle device according to claim 1, wherein the throttle tongue is adapted to the inner contour of the throttle channel in terms of design such that in the neutral position of the throttle tongue there is a free flow cross-section of the throttle channel, which is expediently a minimum free flow cross-section which is smaller than any free flow cross-section present in the possible pivot positions of the throttle tongue.

3. The throttle device according to claim 1, wherein the holding structure is designed as a holding frame completely surrounding the periphery of the throttle channel, wherein the inner circumferential surface of the holding frame expediently forms a channel wall surface of the throttle channel, which together with the pivotable throttle tongue limits the free flow cross-section of the throttle channel.

4. The throttle device according to claim 3, wherein the holding frame has a rectangular cross-sectional contour at least on the inside and expediently also on the outside, wherein the throttle tongue expediently has a rectangular outer contour as seen in the channel longitudinal direction of the throttle channel.

5. The throttle device according to claim 3, wherein the holding frame is sleeve-shaped and extends between two opposite frame end faces, wherein the throttle tongue is attached to the holding frame with its proximal end section in an attachment area spaced apart from the two frame end faces.

6. The throttle device according to claim 1, wherein the throttle tongue has rubber-elastic properties in its entirety such that it can be bent elastically when it pivots, causing a change in the free flow cross-section, wherein the throttle tongue expediently consists of an elastomeric material, wherein the elastomeric material in particular has viscoelastic properties.

7. The throttle device according to claim 6, wherein the throttle tongue is designed with a bending stiffness that decreases from its proximal end section to its distal end section in particular continuously, wherein its tongue cross-section expediently decreases from the proximal end section to the distal end section, in particular through a decreasing tongue thickness.

8. The throttle device according to claim 1, wherein the throttle tongue is designed in such a way that when it pivots from the neutral position, a degressive or linear or progressive change in the cross-section of the free flow cross-section of the throttle channel occurs depending on the pressure difference between the two throttle channel sections.

9. The throttle device according to claim 1, wherein it is designed as a throttle unit having the throttle tongue and the holding structure as integral components, wherein the throttle tongue and the holding structure are integrally formed with one another or connected to one another by a material bond and wherein the throttle unit is expediently made entirely of a material with rubber-elastic properties.

10. The throttle device according to claim 9, wherein the throttle unit is designed as an insert component which can be inserted or is inserted into a fluid channel of a fluid device for its utilization while assuming a use position, wherein it expediently has at least one rubber-elastic sealing bead which surrounds the throttle channel and rests in a sealing manner against a wall surface of the fluid channel in the use position.

11. A fluid device, having at least one fluid channel designed for the flow of a pressurized fluid, which is at least partially designed as a throttle channel, which belongs to a throttle device, according to claim 1, associated with the fluid channel, through which differently sized free flow cross-sections of the throttle channel can be specified.

12. The fluid device according to claim 11, wherein the throttle unit is designed as an insert component which can be inserted or is inserted into a fluid channel of a fluid device for its utilization while assuming a use position, wherein it expediently has at least one rubber-elastic sealing bead which surrounds the throttle channel and rests in a sealing manner against a wall surface of the fluid channel in the use position, and
the throttle unit is inserted as an insert component into the at least one fluid channel.

13. The fluid device according to claim 11, wherein the fluid device is designed as a valve device, which has a valve section, which is passed through by a plurality of fluid channels, among which there is at least one working fluid channel provided for the fluidic connection with a fluid-actuated drive to be actuated, wherein the valve section has at least one electrically actuable directional control valve, by means of which a fluid flow of the pressurized fluid that occurs in the at least one working fluid channel can be controlled, wherein at least one working fluid channel is fitted with the throttle device.

14. The fluid device according to claim 13, wherein the at least one electrically actuable directional control valve can control two working fluid channels of the valve section, which are both respectively fitted with the throttle device.

15. The fluid device according to claim 13, wherein the valve section has a base body separate from the at least one directional control valve, on which body the at least one directional control valve is in particular releasably mounted, wherein the at least one working fluid channel extends with a directional control valve section in the directional control valve and with an adjoining base body section in the base body, wherein the throttle device is expediently arranged either in the base body section or in the directional control valve section of the at least one working fluid channel.

16. The fluid device according to claim 15, wherein the valve section has a plurality of directional control valves which are lined up on the base body and respectively designed to control a fluid flow of the pressurized fluid that occurs in at least one working fluid channel fitted with the throttle device.

17. The fluid system, having fluid devices in the form of a fluid-actuated drive and a valve device for the fluidic actuation of the fluid-actuated drive, having at least one fluid line connecting the valve device to the fluid-actuated drive for transmitting a pressurized fluid, and having at least one throttle device for throttling a fluid flow between the valve device and the fluid-actuated drive, which fluid flow causes a stroke movement of an output member of the fluid-actuated drive, wherein the at least one throttle device is designed according to claim 1 such that the fluid flow of the pressurized fluid can be restricted via a self-adapting free flow cross-section that is dependent on differential pressure, wherein the valve device has a valve section, which is passed through by a plurality of fluid channels, among which there is at least one working fluid channel provided for the fluidic connection with a fluid-actuated drive to be actuated, wherein the valve section has at least one electrically actuable directional control valve, by means of which a fluid flow of the pressurized fluid that occurs in the at least one working fluid channel can be controlled, wherein at least one working fluid channel is fitted with the throttle device.
